(19) United States
(12) Patent Application Publication
(10) Pub. No.: US 2015/0088957 A1
(43) Pub. Date: Mar. 26, 2015

(54) SYSTEM AND METHODS FOR MANAGING APPLICATIONS IN MULTIPLE DEVICES

(71) Applicant: Jenke Wu KUO, San Diego, CA (US)

(72) Inventor: Jenke Wu KUO, San Diego, CA (US)

(73) Assignee: Sony Corporation, Tokyo (JP)

(21) Appl. No.: 14/037,069

(22) Filed: Sep. 25, 2013

(51) Int. Cl. H04L 29/08

(52) U.S. Cl. CPC H04L 67/10
USPC 709/201

(57) ABSTRACT

A device and methods are provided for monitoring and updating a network application across devices by an application state manager. In one embodiment, a method includes launching an application state manager by a first device, wherein the application state manager is associated with a network application executed by the his device and identifying, by the first device, one or more devices executing an application state manager associated with the network application, wherein a second device is identified by the first device. The method may further include exchanging, by the first device, data of the application state manager of the first device with data of an application state manager of a second device.

### FIELD

The present disclosure relates generally to systems and methods for managing applications, and more particularly to a device and methods for managing applications executing in multiple devices.

### BACKGROUND

Computer applications typically operate on a particular platform or operating system. Web applications are usually designed to be accessed via one or more platforms and may be accessed on an individual consumer electronic device that has network capability. Many web applications are implemented as a native code (i.e., platform dependent). Many of today's consumer electronic devices include a web browser or engine to access local or cloud services through interact or a local network. There is a need for management of applications across devices.

It is known to have server based deployment of software and applications to devices. The systems and methods for deploying software to a device do not allow for cross-device and cross-device management of applications. Rather, software deployment is to provide a device with software and in some cases software updates to devices. Application operation is then independent across devices.

### BRIEF SUMMARY OF THE EMBODIMENTS

Disclosed and claimed herein are a device and methods for monitoring and updating a network application across devices by an application state manager. In one embodiment, a method includes launching an application state manager by a first device, wherein the application state manager is associated with a network application executed by the first device, and identifying, by the first device, one or more devices executing an application state manager associated with the network application, wherein a second device is identified by the first device. The method further includes exchanging, by the first device data of the application state manager of the first device with data of an application state manager of a second device. Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a simplified system diagram for managing application execution in multiple devices according to one or more embodiments;

FIG. 2A depicts a process for an application state manager according, to one or more embodiments;

FIG. 2B depicts a process for an application state manager according to another embodiment;

FIG. 3A depicts a simplified block diagram of a device according to one embodiment;

FIG. 3B depicts a simplified block diagram of a device according to another embodiment;

FIG. 4 depicts a process according to one or more embodiments; and

FIG. 5 depicts a process according to one or more embodiments.

### DETAILED DESCRIPTION OF THE EXEMPLARY EMBODIMENTS

### Overview and Terminology

One aspect of the disclosure relates to a device and methods for monitoring and updating a network application using an application state manager. In one embodiment, an application state manager is a network application (e.g., computer application, executable code, etc.) configured to monitor, update and synchronize a network application across one or more electronic devices. The application state manager may be executed independent of a device operating system and may be executed on one or more devices. According to another embodiment, the application state manager is computer executable code separate from the network application to be monitored and managed.

According to one embodiment, an application state manager (ASM) may be configured as a web application state manager (WASM) configured to monitor and synchronize web or network applications. An application state manager, or web application state manager, is implemented as a web application itself, in one or more embodiments. The application state manger may be configured to conduct or activate as a network application using machine independent code (e.g., HTML, JAVA). In that fashion, the application state manager can be executed by any kind of network/web application engine (e.g., commercial browser, JVM (Java Virtual Machine), etc.).

As used herein, a network application is a computer executable program which may be executed by a device and which communicates by way of a computer network with one or more devices or network entities.

According to one aspect of the disclosure, an application state manager may be configured to allow for synchronization of network applications across one or more devices. By way of example, many network applications, such as web browsers, personal communication applications, and social media applications allow for the application to be executed on one or more devices. However, the execution of the network applications does not rely or monitor the execution of the application on another device. One use of an application state manager is to allow for presentation of a network application across multiple devices without requiring the user to manually navigate, and/or input data, to arrive at the same presentation of the application. Another use may be to allow tier a user to transition from one or more devices interchangeably.

In one embodiment, a method for monitoring a network application across devices includes initiating an application state manager on a device and exchanging data for the network application with an application state manager of a second device. By way of example, the method may be performed by a device to allow for a network application to execute across devices. Once launched and activated on the device, the application state manager can discover other devices, and application state managers executed by other devices. Devices and application state mangers may be detected through network broadcasting. An application state manager may be configured to detect or listen for other application state managers, or may be run individually. Once other application state managers are detected, data associated with a network application can be exchanged. Data exchange may include exchange of one or more of configuration, authentication, authorization and data for hosting, applications through the network. According to another embodiment, cross platform network applications can launch, activate and register the application state manager running in the device with one or more network elements. Once launched, an application state manager may be configured to manage an operating system (OS) state and connection of registered applications across devices. As a result, network applications can run across platforms and retain consistent functionality through the user interface. As such, application execution may be provided on one or more devices.

According to another embodiment, an electronic device is provided, such as a consumer electronic, device that may be configured to execute an application state manager for one or more network applications. The device may additionally be configured to monitor a network application executed by the device and exchange data with one or more other application state managers, such as application state managers executed by another device. Monitoring a network application may be beneficial to allow for synchronization of an application across devices.

In another embodiment, a system is providing for monitoring and synchronizing execution of a network application across devices using an application state manager. The system may allow for a device to communicate with one or more other devices based on application state managers executed for network application and based on network communication. In addition, the system may allow for interconnection and/or interoperability of devices across a network. Although the disclosure is described as relating to network applications, it should be appreciated that the devices and methods described herein may be employed for one or more additional benefits and uses.

In yet another embodiment, a computer program product, is provided for monitoring and updating a network application across devices. The computer program product may be stored by non-transitory memory of a device and may be executed by the device.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

In accordance with the practices of persons skilled in the art of computer programming, one or more embodiments are described below with reference to operations that are performed by a computer system or a like electronic system. Such operations are sometimes referred to as being computer-executed. It will be appreciated that operations that are symbolically represented include the manipulation by a processor, such as a central processing unit, of electrical signals representing data bits and the maintenance of data bits at memory locations, such as in system memory, as well as other processing of signals. The memory locations where data bits are maintained are physical locations that have particular electrical, magnetic, optical, or organic properties corresponding to the data bits.

When implemented in software, the elements of the embodiments are essentially the code segments to perform the necessary tasks. The code segments can be stored in a processor readable medium, which may include any medium that can store or transfer information. Examples of the processor readable mediums include an electronic circuit, a semiconductor memory device, a read-only memory (ROM), a flash memory or other non-volatile memory floppy diskette, a CD-ROM, an optical disk, a hard disk, a non-transitory medium, etc.

### Exemplary Embodiments

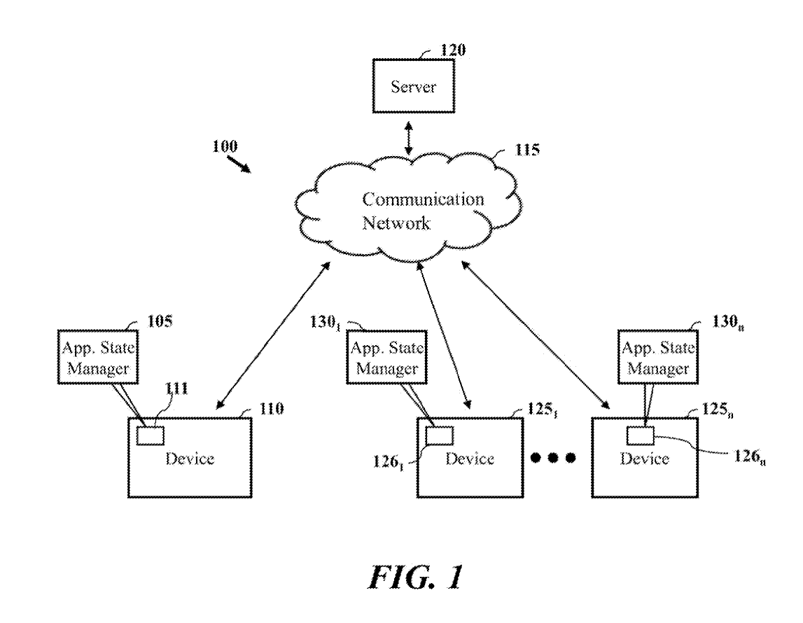

In one embodiment, an application state manager may be configured to manage and update network applications across devices associated with a network system. Monitoring may be performed by one or more devices and can include network communication. Referring now to the figures, FIG. 1 depicts a simplified system diagram according to one or more embodiments. System 100 may apply to content-server type network application entities or peer-to-peer applications, including but not limited to gaming applications, social network applications, personal cloud service applications and network applications in general. As shown in FIG. 1, system 100 includes device 110, communication network 115, server 120 and devices 125₁₋ₙ. System 100 may support operation of one or more application state managers.

Application state manager 105 may be executed by device 110. According, to one embodiment, application state manager 105 may be executed by device 110 for managing and updating a network application across devices. According to another embodiment, application state manager 105 is implemented as a web application and is associated with a network application 111 executed by device 110. In yet another embodiment, application state manager 105 may be configured to monitor operation and one or more states of network application 111 executed by device 110 and exchange data with one or more other application state managers, such as one or more of application state managers 130₁₋ₙ. Application state managers 130₁₋ₙ may each be executed by a device, such as one of devices 125₁₋ₙ. In addition, application state managers 130₁₋ₙ may each be associated with a network application, such as applications 126₁₋ₙ executed by devices 125₁₋ₙ. Each application state manager may be an operating system independent application.

Each application state manager of system 100 may be configured to discover and connect devices together to conduct application functionality across one or more platforms. Exemplary use cases of application state manager control include control of one or more of gaming applications and consoles, media players, remote user interfaces, and other types of applications. According to another embodiment, the application state manager can also serve as a search engine, and/or provide data editing (e.g., user may remote access other devices through the application state manager to search or archive data or files individually). The application state manager may allow for browsing data pictures cached in other devices (e.g., image data, social media data, etc.) through network services (e.g., cloud services) and determine whether to save cache data to another backup device. In this fashion, network applications across platforms may run together simultaneously without multi-process operating systems involved and while running as multiple web applications on multiple devices. Further, an application state manager can synchronize network applications running cross devices as platform system independent. In contrast to conventional applications, like personal information managers that synchronize presentation of data (e.g., email), an application state manager is not limited to synchronizing the message data for an application. For example, when configured to monitor and update a network application for message (e.g., email, messages, comments, etc.), the application state manager may be configured to detect presentation states of an application and may be configured to allow for tracking and synchronizing additional data types and data presentation formats.

Devices supported by system 100 in FIG. 1 may be end user devices, such as consumer electronic devices. In exemplary embodiments, device 110 and devices 125₁₋ₙ, may be similar types of devices. According to another embodiment, device 110 and devices 125₁₋ₙ may be different types of devices. Each of device 110 and devices 125₁₋ₙ of system 100 may relate to one or more device types, such as consumer electronic, personal, mobile, handheld, computer, media player, gaming system, gaming console, display devices, etc.

Communication network 115 may allow for one or more of wired and wireless communication. For example, communication network 115 may allow for network based communications including, but not limited to, LAN. WAN, WI-FI, etc. Devices 110 and 125₁₋ₙ of FIG. 1 may be configured to connect to server 120 via communication network 115, which may include wired and/or wireless components. Server 120 may be configured to provide contact and data to one or more devices, including data for one or more network applications. System 100 may additionally allow for linking one or more application state managers, such as application state manager 105 to an application state manager associated with another device. Although system 100 is described, above as having a single server, it may be appreciated that the system include a plurality of servers.

According to one embodiment, application state managers of system 100 may communicate via communication network 115 which may include wired and/or wireless communication. In certain embodiments, communication among devices may be facilitated and/or involve communication with a server, such as server 120. Server 120 may be associated with a network application executed by devices 110 and 125₁₋ₙ of system 100.

In one embodiment, server 120 may relate to an application server to provide data for a network application, such as network application 111. In certain embodiments server 120 may be configured to link application state managers. In other embodiments, application state managers of system 100 may operate independent of server 120.

Application state manager 110 may be executed by device 105 to manage application 111. In certain embodiments, application state manager 110 is operating system independent, in that it may be executed by a device independent of the operating system of code controlling the device. By way of example, application state manager 110 may be code (e.g., HTML, Java, etc.) to be executing by a network/web application engine, such as a commercial browser or JVM Java virtual machine. Application state manager 110 may additionally provide cross-platform operation for managing applications of devices.

One benefit of an application state manager, as described herein, may be to allow for network applications to be synchronized across a plurality of devices. By way of example, devices running applications, such as device 110 and device 125₁, may each be executing a web application. Operation of the web application may be controlled by the device executing the application and based on one or more user input values entered into the application. In the case of the network application being a search engine for example, a user entry could be a search string. Thus, when a user picks up a second device, any work on the application of the first device must be reentered on the second device to arrive at the same screen. According to one embodiment, an application state manager may be configured to monitor use of an application and allow for the user to begin working with an application on a first device, such as device 110 and then continue working on the application on a second device, such as device 125₁, without having to enter data, search string, etc. In addition to entering data into forms and navigating to a desired portion (e.g., presentation) of a network application, an application state manager may also allow for the user to operate one or more devices interchangeably. For example, work interchangeably on the first device and the second device.

According to another embodiment, an application state manager, such as application state manager 105, may be configured to detect one or more states of an application to determine network application data to be provided to another application state manager. Data may be stored initially during operation and then may be stored on the device to pull from later. Alternatively, or in combination, data may be stored until a device is turned off.

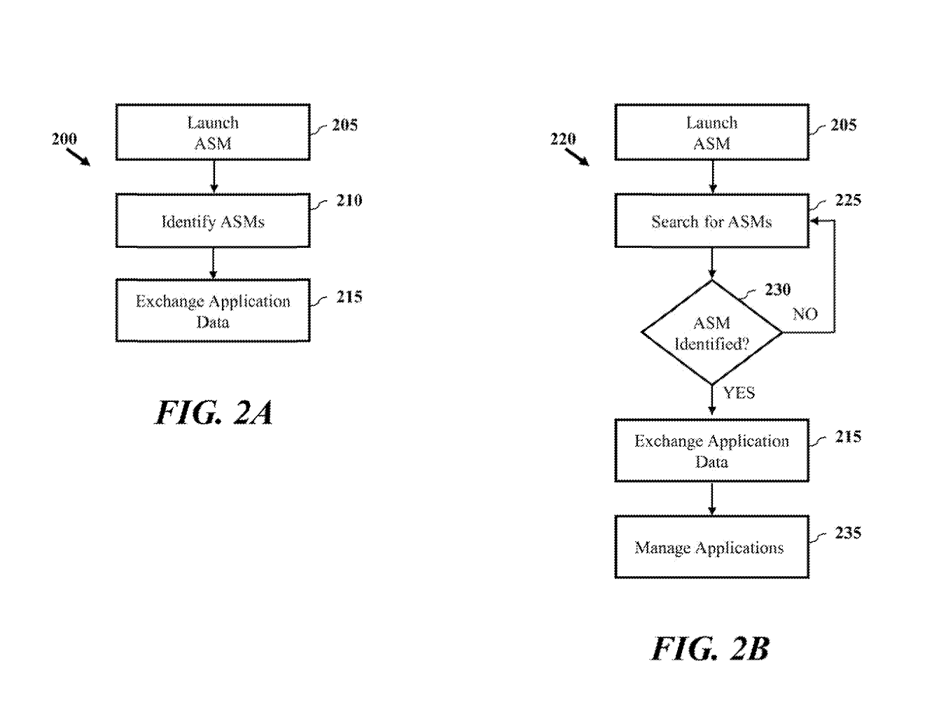

Referring now to FIGS. 2A-2B, processes are depicted for monitoring and updating a network application across devices by an application state manager according to one or more embodiments. Process 200 of FIG. 2A and process 220 of FIG. 2B may each be executed by a device (e.g., device 105) to launch and execute an application state manager. Processes 200 and 220 may be employed for managing application execution in multiple devices according to one or more embodiments. According to one embodiment, the processes described herein can allow a user to run applications across platforms. In addition, many network applications can be complimented with an application state manager without changing the code across platforms and network applications may be hosted by the application state manager.

Referring to FIG. 2A, process 200 may be initiated by launching an application state manager by a first device at block 205. The application state manager launched at block 205 is associated with a network application executed by a device (e.g., a first device) at block 205. The network application executed by a device may be configured to launch the application state manager. Process 200 is described with respect to an end user device; however, it should be appreciated that other types of devices may execute the application state manager.

At block 210, one or more devices executing an application state manager associated with the network application may be identified. Identification of devices can include identification of a second device at block 210. According to one embodiment, identifying at block 210 may include searching and/or checking for one or more devices executing, an application state manager for the network application. In another embodiment, identifying at block 210 may include identifying one or more devices executing an application state manager, and/or identifying devices associated with the first device is based on one or more of proximity, an identified user, and registration of devices.

Process 200 may continue with exchanging, by the first device, data of the application state manager of the first device with data of an application state manager of a second device at block 215. In one embodiment, exchanging data of the application state manager at block 215 includes transferring one or more of a configuration, authentication state, and action associated with the network application to an application state manager of the second device. In one embodiment, the application state manager synchronizes the network application across the first device and the second device based on exchanged application data. Once data is exchanged, one or more devices may interoperate over a communication network. By way of example, one device may be configured to trace media streams, another device may playback the streams, and another device may present the remote user interface of media metadata.

In contrast to operation by a server for updating devices or providing rollouts of software, exchanging application data at block 215 provides data for presenting the application with a similar state or presentation format of the network application that is being executed on another device. As such, in certain embodiments, the underlying code of the software application is not permanently changed, as would be in the case of a server update of software. In addition to providing network application data, application state managers can manage application on one or more devices and can hand off duties. For example, an application state manager on a first device may hand-off managing and/or control to an application state manager of a second device. In addition, exchanging application data may allow for linking one or more devices.

Referring to FIG. 2B, process 220 is provided for a process for monitoring and updating a network application similar to process 200 of FIG. 2A. Process 220 is shown and may be initiated by launching an application state manager by a first device. The application state manager launched at block 205 is associated with a network application executed by a device (e.g., a first device). According to one embodiment, the application state manager can monitor activities of one or more devices, activities including security, sharing, backup, personnel, task assistance, and presentation. The application state manager can connect devices together by way of web application engines (e.g., browsers, JVM, etc.) to execute a dedicated web application concurrently with a network application. The application state manager can allow for a multi-process browser to execute on a single application and provide users with a unique and seamless experience and services over a plurality of devices. According to one embodiment, the application state manager may be extendable and expandable. The application state manager may be a virtual application and may provide more efficient personal application or cloud service appellation. The application state manager may be configured to support private or public network topologies. In addition, the application state manager can involve remote user interface cross platforms to provide seamless user interface presentation.

Process 220 is described with respect to an end user device; however, it should be appreciated that other types of devices may execute the application state manager. The description of elements of process 200 similar to elements of process 220 are incorporated by reference.

According to one embodiment, process 220 may include searching for one or more application state managers at block 225. In that fashion, a device executing an application state manager may be linked to one or more pre-identified devices. For example, searching may be based on one or more of devices identified by a user, devices linked to a user, and applications linked to user credentials, in certain embodiments, searching for an application state manager at block 225 may be based on communications with a server, or may be based on server and application identification in combination. Searching, for an application state manager, or other device, may include initiating communication with another device, such as sending a message. In other embodiments, searching for another application state manager may be based on data generated by a server. In some embodiments, an application state manager may be configured to remotely access (e.g., wake up) other devices.

At decision block 230, the application state manager can check if an application state manager has been identified. When an application state manager has not been identified (e.g., “NO” path out of decision block 230), process 220 may continue searching for application state managers at block 225. When an application state manager has been identified (e.g., “YES” path out of decision block 230), process 220 may continue to block 215 for exchanging application data. Process 220 may additionally include managing applications at block 235. By way of example, once application state managers have exchanged application data, one or more of the application state managers may continue to monitor and update the network application to provide updates and to identify application state managers during execution of a network application by a device. Managing network applications by the application state manager may include launching, activating, and registering application state managers of identified devices. The application state manager can manage applications for one or more of social media, gaming and personal applications. Managing may also include transferring control of a network application by the application manager of a first device to the application manager of a second device.

Managing applications at block 235 may include updating an application, or presentation of an application, based on detection of a user setting. For example, the user setting may be preset to allow for specified updates to presentation of a network application, or may be based on a detected user input accepting and/or declining update of the network application.

According to one embodiment, the application state manager can update multiple applications, sub-applications, etc. Managing applications by an application state manager at block 235 allows for the underlying code of a software application to remain the same in certain embodiments. For example, the application state manager can be executed without changing the underlying, code of a network application, rather it may allow for monitoring and/or updating of the state of the application, inclusion of user data, and navigation to a point of the application. In addition to providing information for state changes, user provided data and selections, application state managers can manage application on one or more devices, and can hand off duties to one or more application state managers. An application state manager on a first device may hand-off managing and/or control to an application state manager of a second device. In addition, exchanging application data may allow for linking, one or more devices to provide cross-platform management of a network application.

According to another embodiment, managing by an application state manager may be based on the application state manager creating a profile or log of network application operation thr each device a network application is executed on, and comparing the profile or log to determine how to update presentation or control operation of the network application.

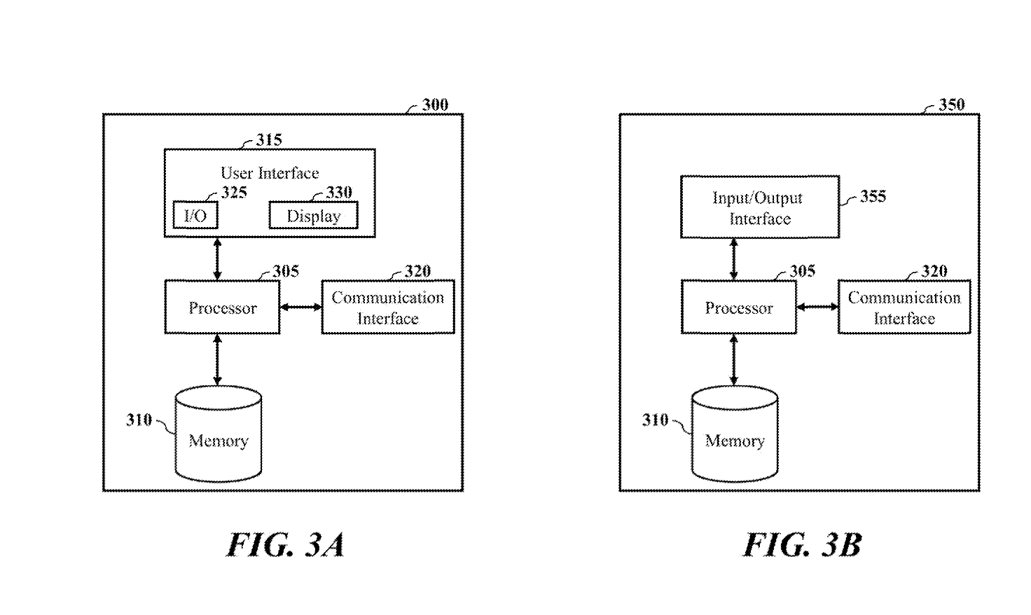

The processes described in FIGS. 2A-2B may be employed by a device, such as the devices of FIGS. 3A-3B described below, a consumer electronic device, etc. In certain embodiments, the processes of FIGS. 2A-2B may be embodied in computer program products.

Referring now to FIG. 3A, a simplified, block diagram is depicted of a device according to one or more embodiments. Device 300 may relate to one or more of personal communication device, media player, imaging device, mobile electronic device, gaming device, gaming console, display device and consumer electronic device in general. Alternatively, or in combination, device 300 may be one or more of a display device, set-top box, communication device, media player, gaming device or computing device in general. In certain embodiments, the devices of FIG. 1 (e.g., device 110 and devices 125₁₋ₙ) may be configured similarly to device 300. Device 300 may be configured to execute one or more applications, including a network application and an application state manager. In certain embodiments, device 300 may be configured to allow for an application state manager executed by the device to exchange data with an application state manager of another device. Device 300 may be configured to access a server to allow for network based management of device applications and features.

Device 300 includes processor 305, memory 310, user interface 315, and communication interface 320. User interface 315 may include an input/output (110) interface 325 and display 330. Elements of device 300 may be configured to communicate and interoperate with processor 305 by a communication bus. Processor 305 may be configured to control operation of device 300 based on one or more computer executable instructions stored in memory 310. In one embodiment, processor 305 may be configured to provide an application state manger. Memory 310 may relate to one of RAM and ROM memories and may be configured to store one or more files, and computer executable instructions for operation of device 300. Although depicted as a single memory unit, memory 310 may relate to one or more of internal device memory and removable memory. Memory 310 may store one or more audio and video files. According to another embodiment, memory 310 can store one or more computer readable instructions to allow for device 300 to perform the processes of FIGS. 2A-2B, 4 and 5.

According, to one embodiment, device 300 may include user interface 315 to detect user commands and/or output data. As shown in FIG. 3A, user interface 315 includes input/output (I/O) interface 325 configured to output data and/or commands to one or more output devices, and display 330. According to one embodiment, I/O interface 325 may be configured to receive one or more user commands. I/O interface 325 may include one or more buttons to control operation of device 300 including controlling selection of content for display and controlling operation of device 300. Input buttons of I/O interface 325 may include one or more buttons for user input, such as a such as a numerical keypad, volume control, menu controls, pointing device, track ball, mode selection buttons, and playback functionality (e.g., play, stop, pause, forward, reverse, slow motion, etc). Input buttons of I/O interface 325 may include hard and soft buttons, wherein functionality of the soft buttons may be based on one or more applications running on device 300. In certain embodiments, device 300 may include display 330 to display image data, such as video data and graphics data, alert messages, and display one or more applications executed by processor 305.

Communication interface 320 may include one or more elements to allow for communication by device 300 by wired or wireless communication. Communication interface 320 may include one or more ports for receiving data, including ports for removable memory. Communication interface 320 may be configured to allow for network based communications including but not limited to LAN. WAN, Wi-Fi, etc.

FIG. 3B depicts a device according to another embodiment. Elements of device 350 of FIG. 3B operate similar to like numbered elements of device 300 in FIG. 3A, accordingly the description of these elements above is incorporated by reference. For example, Device 350 includes processor 305, memory 310 and communication interface 320. Device 350 may relate to one or more electronic devices that do not include a display. According to another embodiment, device 350 includes input/output (I/O) interface 355 which may be configured to receive one or more user commands. I/O interface 355 may include one or more control elements (e.g., buttons, sensors, etc.) to control operation of device 350.

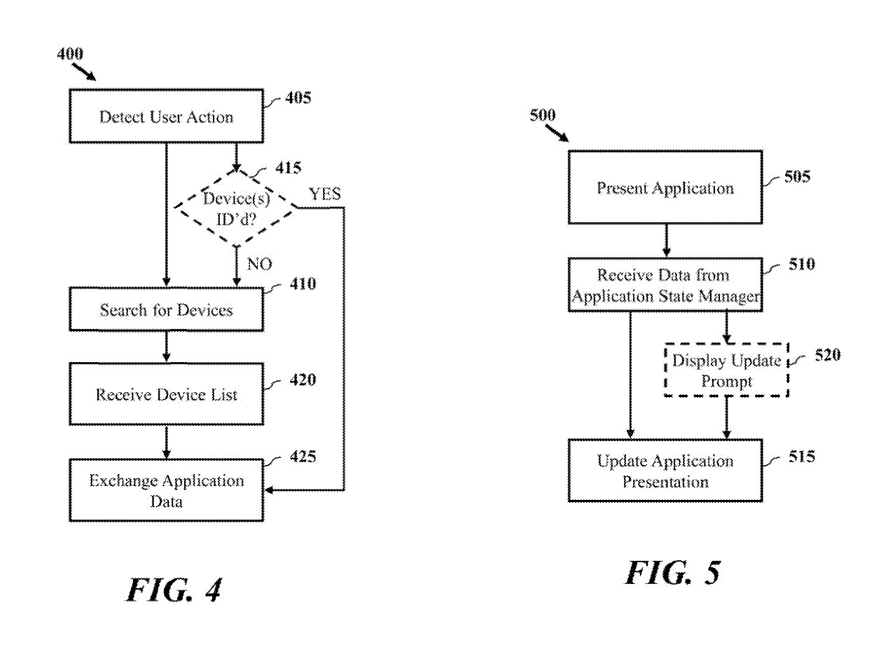

According to one embodiment, an application state manager may be configured to monitor and update presentation of a network application to a user based on one or more detected user interactions with a device. FIG. 4 depicts a process for exchanging data between one or more application state managers based on detected user actions according to one or more embodiments. Process 400 may be employed for updating a network application across one or more devices. In certain embodiments, process 400 may synchronize presentation of network applications on one or more devices.

Process 400 may be initiated by detecting user action at block 405. By way of example, a user action may be one or more of a selection, navigational command, entry, log-in, and input to a network application. In certain embodiments, an application state manager executed by a device may detect and/or track user actions with respect to the network application.

Based on detected user actions, the application state manager may be configured to search for devices at block 410. In one embodiment, searching for devices may include network broadcasting to identify one or more devices associated with a user. According to another embodiment, process 400 may optionally include determining if devices are identified at decision block 415 following detection of a user action. By way of example, when the device has identified devices associated with an application (e.g., “YES” block out of decision block 415), the application sate manager can proceed to block 425 and exchange application data with one or more identified devices based on the detected user action. In one embodiment, exchanging application data may include transmitting and/or synchronizing between states of an application. When the device has not identified devices associated with an application (e.g., “NO” block out of decision block 415), the application state manager can proceed to block 410 and search for devices.

In certain embodiments, an application state manager is configured to receive a device List at block 420 identifying one or more devices based on the search for devices at block 410. The device list may be one or more communications from a network entity, such as a server or network device, identifying devices executing an application state manager for the network application. In certain embodiments, the device list may include identification of application state managers associated with other network applications but tied to the requests based on identification of a user, a connection to the device detecting the user action, etc.

Based on identified devices, such as devices identified in block 420, the application state manager can exchange application data at block 425.

According to another embodiment, application state managers may be configured to update presentation of a network application on a device based on data received from another application state manager. Referring to FIG. 5, a process is shown for updating the presentation of a network application according to one or more embodiments. Process 500 may be performed by a device executing an application state manager. Process 500 may be initiated by presenting a network application at block 505.

At block 510, an application state manager executed by a device receives data from application state manager executed by another device. According to one embodiment, the application state manager executed by the device may be configured to monitor the state of the network application at predetermined time intervals. Based on the data received at block 510, the application state manager on the receiving device can update presentation of the network application at block 515. In certain embodiments, process 500 may optionally include displaying an update prompt at block 520, such as a graphical element, on a device executing the application state manager to notify a user for the update. Updating may include displaying graphical output by the first device to indicate operation of the application state manager.

While this disclosure has been particularly shown and described with references to exemplary embodiments thereof, it will be understood by those skilled in the art that various changes in form and details may be made therein without departing from the scope of the claimed embodiments.

What is claimed is:

1. A method for monitoring and updating a network application across devices by an application state manager, the method comprising the acts of:
launching, an application state manager by a first device, wherein the application state manager is associated with a network application executed by the first device;
identifying, by the first device, one or more devices executing an application state manager associated with the network application, wherein a second device is identified by the first device; and
exchanging, by the first device, data of the application state manager of the first device with data of an application state manager of a second device.

2. The method of claim 1, wherein the network application executed by the first device launches the application state manager.

3. The method of claim 1, wherein launching includes initiation of the application state manager based on one or more of initiation of the network application by the first device, changes in state of the network application, and identification of one or more devices linked with the first device.

4. The method of claim 1, wherein an application state manager synchronizes the network application across the first device and the second device.

5. The method of claim 1, wherein each application state manager is an operating system independent network application.

6. The method of claim 1, wherein identifying includes checking for one or more devices executing an application state manager for the network application.

7. The method of claim 1, wherein identifying one or more devices executing an application state includes of identifying devices associated with the first device is based on one or more of proximity, an identified user and registration of devices.

8. The method of claim 1, wherein exchanging data of the application state manager includes transferring of one or more of a configuration, authentication state, and action associated with the network application to au application state manager of the second device.

9. The method of claim 1, further comprising monitoring the state of the network application by the application state manager of the first device at predetermined time intervals.

10. The method of claim 1, further comprising managing network applications by the application state manager including launching, activating, and registering application state managers of identified devices.

11. The method of claim 1, wherein the application state manager manages applications for one or more of social media, gaming and personal applications.

12. The method of claim 1, further comprising transfer control of the network application by the application manager of the first device to the application manager of the second device.

13. The method of claim 1, further comprising displaying graphical output by the first device to indicate operation of the application state manager.

14. A device comprising:
a communication module,
a memory, and
a processor coupled to the sensor and the communication module, the processor configured to:
launching an application state manager by a the device, wherein the application state manager is associated with a network application executed by the device;
identifying, by the device, one or more devices executing an application state manager associated with the network application, wherein a second device is identified by the device; and
exchanging, by the device, data of the application state manager of the device with data of an application state manager of a second device.

15. The device of claim 14, wherein the network application executed by the device launches the application state manager.

16. The device of claim 14, wherein launching includes initiation of the application state manager based on one or more of initiation of the network application by the device, changes in state of the network application, and identification of one or more devices linked with the device.

17. The device of claim 14, wherein an application state manager synchronizes the network application across the device and the second device.

18. Time device of claim 14, wherein, each application state manager is an operating system independent network application.

19. The device of claim 14, wherein identifying includes checking for one or more devices executing an application state manager for the network application.

20. The device of claim 14, wherein identifying one or more devices executing an application state includes of identifying devices associated with the device is based on one or more of proximity, an identified user, and registration of devices.

21. The device of claim 14, wherein exchanging data of the application state manager includes transferring of one or more of a configuration, authentication state, and action associated with the network application to an application state manager of the second device.

22. The device of claim 14, further comprising monitoring the state of the network application by the application state manager of the device at predetermined time intervals.

23. The device of claim 14, further comprising managing network applications by the application state manager including launching, activating, and registering application state managers of identified devices.

24. The device of claim 14, Wherein the application state manager manages applications for one or more of social media, gaming and personal applications.

25. The device of claim 14, further comprising transfer control of the network application by the application manager of the device to the application manager of the second device.

26. The device of claim 14, further comprising displaying graphical output by the first device to indicate operation of the application state manager.

27. A computer program product stored on computer readable medium including computer executable code for a network application across devices by an application state manager, the computer program product comprising:
computer readable code to launch an application state manager by a first device, wherein the application state manager is associated with a network application executed by the first device;
computer readable code to identify, by the first device, one or more devices executing an application state manager associated with the network application, wherein a second device is identified by the first device; and
computer readable code to exchange, by the first device, data of the application state manager of the first device with data of an application state manager of a second device.
